(19) United States
(12) Patent Application Publication
(10) Pub. No.: US 2023/0060290 A1
(43) Pub. Date: Mar. 2, 2023

(54) METHOD, INFORMATION PROCESSING APPARATUS AND PERFORMANCE EVALUATION SYSTEM

(71) Applicant: CASIO COMPUTER CO., LTD., Tokyo (JP)

(72) Inventors: Junichi MINAMITAKA, Tokyo (JP); Junichi MIYASAKA, Tokyo (JP); Akira SAKASHITA, Kawasaki-shi (JP); Hiroki SATO, Tokyo (JP); Mitsuhiro YONEZAWA, Tokyo (JP); Kenya NOZAKI, Tokyo (JP); Kiyohito SUZUKI, Tokyo (JP)

(73) Assignee: CASIO COMPUTER CO., LTD., Tokyo (JP)

(21) Appl. No.: 17/877,330

(22) Filed: Jul. 29, 2022

(30) Foreign Application Priority Data
Aug. 31, 2021 (JP) 2021-141323

(51) Int. Cl. G10H 1/00

(52) U.S. Cl. CPC G10H 1/0008; G10H 2210/091; G10H 2210/081

(57) ABSTRACT

There is provided a method for a computer to perform evaluating rapid chord playing and/or tonality based on performance actions of a performance; and instructing, during the performance, an outputter to output a reaction sound corresponding to the evaluation.

### CROSS-REFERENCE TO RELATED APPLICATIONS

This application is based upon and claims the benefit of priority from the prior Japanese Patent Application No. 2021-141323, filed on Aug. 31, 2021, the entire contents of which are incorporated herein by reference.

### BACKGROUND

### Technical Field

The present disclosure relates to a method, an information processing apparatus, and a performance evaluation system.

There have been techniques for evaluating the performance of a user playing a piece of music. For example, JP2001-145778A discloses a technique to compare detected actions with action contents described in object data that guides user's performance and, on the basis of how much the detected actions match with the action contents, display the evaluation result on a monitor.

### SUMMARY

However, the known art evaluates the user's performance on the basis of whether the user's performance actions match with correct data. The known art is therefore unable to evaluate improvised (ad-lib) performances.

One of the advantageous effects of the present disclosure is that a performance can be appropriately evaluated even if the performance is improvised.

There is provided a method for a computer to perform evaluating rapid chord playing and/or tonality based on performance actions of a performance; and instructing, during the performance, an outputter to output a reaction sound corresponding to the evaluation.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is an example of overall configuration of a performance evaluation system according to an embodiment of the present invention;

FIG. 2 is a flowchart of a performance evaluation process to be executed by a central processing unit (CPU) shown in FIG. 1;

FIG. 3 is a flowchart of a performance information process to be executed in Step S6 of FIG. 2;

FIG. 4 is a flowchart of a timer process to be initiated in Step S2 of FIG. 2;

FIG. 5 is a flowchart of a rapid-playing evaluation process to be executed in Step S26 of FIG. 4;

FIG. 6 is a flowchart of an accuracy evaluation process to be executed in Step S27 of FIG. 4;

FIG. 7 shows timings of outputting reaction sounds from the start to the end of the performance evaluation process in a time series; and

FIG. 8 is a histogram of note-on intervals (intervals between performance actions).

### DETAILED DESCRIPTION

Hereinafter, an embodiment of the present invention is described with reference to the drawings. The embodiment described below includes various limitations technically preferable for carrying out the present invention. The scope of the present invention is not limited to the following embodiment or illustrated examples.

### [Configuration of Performance Evaluation System 100]

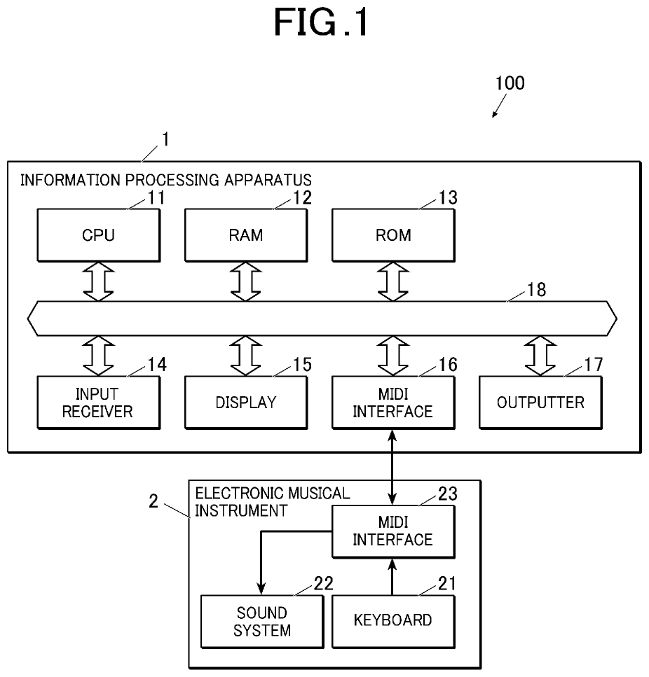

FIG. 1 shows an overall configuration of a performance evaluation system 100 according to the present invention. The performance evaluation system 100 includes an information processing apparatus 1 and an electronic musical instrument 2 that are connected to each other via communication interfaces (in this embodiment, Musical Instrument Digital Interface (MIDI) interfaces).

### [Configuration of Information Processing Apparatus 1]

The information processing apparatus 1 evaluates a performance with the electronic musical instrument 2 on the basis of note data corresponding to performance actions on the electronic musical instrument 2. The information processing apparatus 1 may be a tablet personal computer (PC), a laptop PC, or a smartphone, for example.

As shown in FIG. 1, the information processing apparatus 1 includes: a central processing unit (CPU) 11; a random access memory (RAM) 12; a read only memory (ROM) 13; an input receiver 14; a display 15; an MIDI interface 16; and an outputter 17. These components of the information processing apparatus 1 are connected via a bus 18.

The CPU 11 reads programs stored in the ROM 13, loads the programs into the work area of the RAM 12, and executes various processes by controlling the components of the information processing apparatus 1 in accordance with the loaded programs. For example, the CPU 11 executes the performance evaluation process to be described later in cooperation with the programs stored in the ROM 13.

The RAM 12 provides storage areas for temporarily storing programs, input/output data, parameters, and so forth when the CPU 11 executes the processes.

The ROM 13 stores the programs and data to be used in the programs. The programs in the ROM 13 include a program(s) for executing the performance evaluation process to be described later.

The ROM 13 at least stores data of sounds constituting one key. For example, the ROM 13 stores data of sounds constituting C major, namely the sounds (notes) of C, D, E, F, G, A, and B.

The ROM 13 also stores data of reaction sounds and sound effects used in the performance evaluation process described below. For example, the ROM 13 stores the following sound data and sound-effect data: a reaction sound to be output before a performance starts (e.g., encouraging clapping); a reaction sound to be output when the performance starts (e.g., clapping); a reaction sound to be output when the performance ends (e.g. clapping); and reaction sounds to be output when the performance is highly evaluated (reaction sound types 1 to 3).

The input receiver 14 includes a key input receiver (e.g., keyboard) and a pointing device (e.g., mouse). The input receiver 14 receives key inputs and position-change inputs from a user (operator) and outputs the input information to the CPU 11. The input receiver 14 may consist of a touchscreen.

The display 15 consists of a liquid crystal display (LCD) or an electro-luminescence (EL) display, for example. The display 15 displays various contents in accordance with display information instructed by the CPU 11.

The MIDI interface 16 is connected to a MIDI interface 23 of the electronic musical instrument 2. The MIDI interface 16 functions as an obtainer that obtains data including note data. The note data is output by the electronic musical instrument 2 according to the performance.

The outputter 17 includes a digital-analog (D/A) converter, an amplifier, and a speaker. In accordance with output instructions by the CPU 11, the ouptutter 17 outputs sounds and sound effects on the basis of sound data and sound-effect data.

### [Configuration of Electronic Musical Instrument 2]

The electronic musical instrument 2 is a keyboard instrument, for example. The electronic musical instrument 2 includes a keyboard 21, a sound source-sound system 22, and the MIDI interface 23.

The keyboard 21 has multiple notes (performance action receivers) on which the user performs performance actions.

The sound source-sound system 22 generates musical sound waveforms according to the user's performance actions on the keyboard 21 and output the generated waveforms.

The MIDI interface 23 is connected to the MIDI interface 16 of the information processing apparatus 1 and outputs note data of the performance to the information processing apparatus 1.

The electronic musical instrument 2 outputs note data (performance action information) to the information processing apparatus 1 via the MIDI interface 23 every time the user makes a performance action on any of the notes constituting the keyboard 21 (i.e., every time the user strikes/releases any note). More specifically, when a note of the keyboard 21 is struck, the electronic musical instrument 2 outputs note data that includes a note-on message indicating that the note is struck; the note number (pitch) of the struck note; and the velocity. When the note of the keyboard 21 is released, the electronic musical instrument 2 outputs note data that includes a note-off message indicating that the note is released; the note number (pitch) of the released note; and the velocity.

### [Operation of Information Processing Apparatus 1]

### (Performance Evaluation Process)

Next, the operation of the information processing apparatus 1 in this embodiment is described.

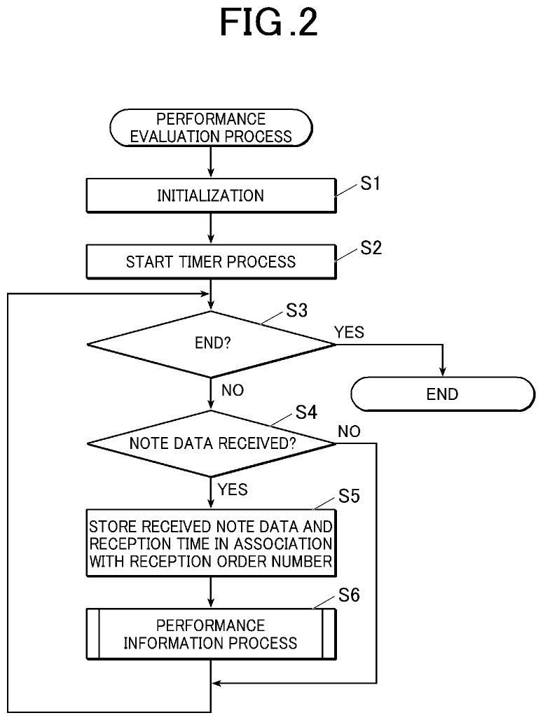

FIG. 2 is a flowchart of the performance evaluation process to be executed by the CPU 11. The performance evaluation process is executed when the information processing apparatus 1 receives an instruction to execute the process via the input receiver 14. The performance evaluation process shown in FIG. 2 is performed by the CPU 11 in cooperation with the program stored in the ROM 13.

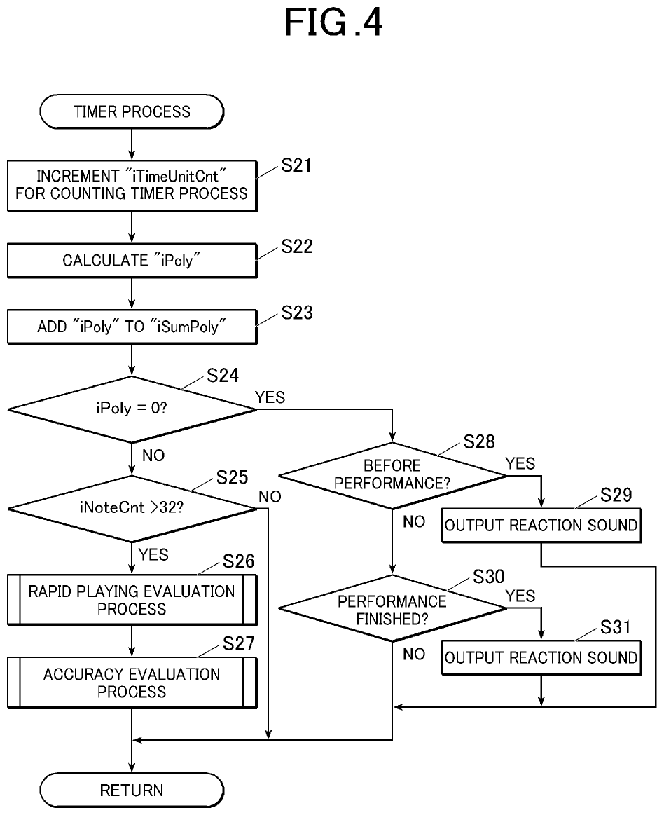

The CPU 11 firstly initializes variables to be used in the performance evaluation process (Step S1) and initiates a timer process (see FIG. 4) (Step S2).

Herein, the timer process is executed at a predetermined cycle (e.g., at the cycle of 10-20 milliseconds) during the performance evaluation process. The timer process is described in detail later.

The CPU 11 determines whether a condition to end the performance evaluation process is met (Step S3).

For example, the CPU 11 determines that the condition to end the performance evaluation process is met when (i) it is determined that the performance ends in the timer process or (ii) the performance evaluation process is canceled via the input receiver 14.

When determining that the condition to end the performance evaluation process is not met (Step S3: NO), the CPU 11 determines whether the MIDI interface 16 has received note data from the electronic musical instrument 2 (Step S4).

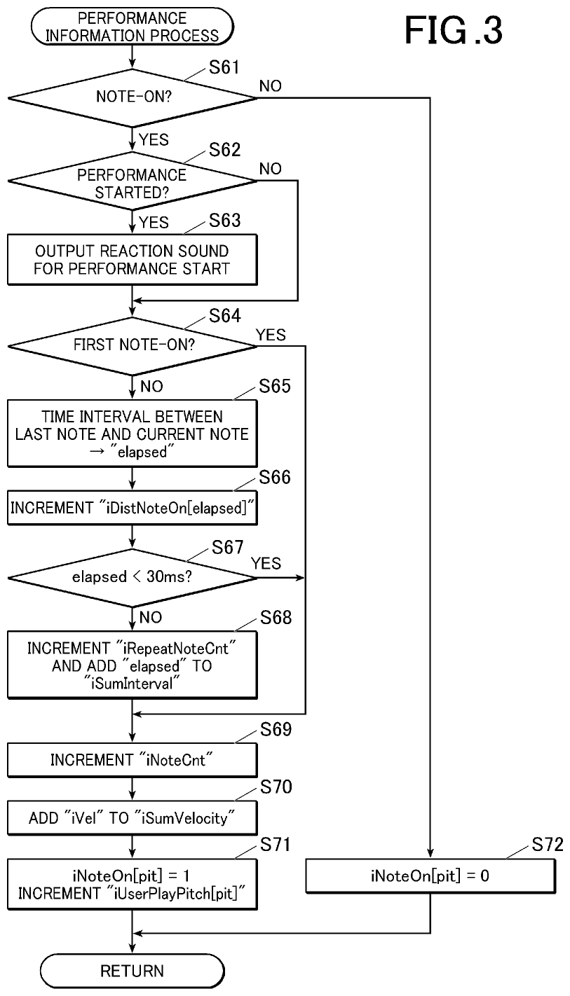

When determining that the MIDI interface 16 has received note data from the electronic musical instrument 2 (Step S4: YES), the CPU 11 stores, in the RAM 12, the received note data and the time of receipt in association with the number indicating the order of receipt (Step S5). The CPU 11 then executes the performance information process (see FIG. 3) (Step S6).

### (Performance Information Process)

FIG. 3 is a flowchart of a performance information process to be executed in Step S6 of FIG. 2. The performance information process is executed by the CPU 11 in cooperation with the program stored in the ROM 13.

In the performance information process, the CPU 11 determines whether the received note data includes a note-on message (Step S61).

When determining that the received note data includes a note-on message (Step S61: YES), the CPU 11 determines whether the note-on message is the note-on message at the start of performance (Step S62).

Herein, the CPU determines whether the note-on message is the note-on message at the start of performance by determining whether the received note-on message is the first note-on message after the performance evaluation process starts. When the note-on message is the first note-on message after the performance evaluation process starts, the CPU 11 determines that the note-on message is the note-on message at the start of performance.

When determining that the note-on message is the note-on message at the start of performance (Step S62: YES), the CPU 11 instructs the outputter 17 to output a reaction sound (e.g., clapping at the start of performance) (Step S63) and proceeds to step S64.

When determining that the note-on message is not the note-on message at the start of performance (Step S62: NO), the CPU 11 proceeds to Step S64.

In Step S64, the CPU 11 determines whether the received note-on message is the first note-on message (Step S64).

When determining that the received note-on message is not the first note-on message (i.e., second or later note-on message) (Step S64: NO), the CPU 11 calculates the time interval between the reception time of the last note-on message and the reception time of the current note-on message (note-on time interval) and stores the calculated time interval in a variable “elapsed” (Step S65). The CPU 11 also increments a variable “iDistNoteOn[elapsed]” (Step S66). The variable “iDistNoteOn[elapsed]” stores the frequency of the time interval as a histogram.

Herein, the calculated time interval is quantized within a certain range. When quarter notes (crotchets) are played at 120 beats per minute (bpm), the time interval is 0.5 second. Similarly, when quarter notes are played at 121 bpm, the time interval is approximately 0.4958 second. The first digit of the bpm (tempo) can be obtained by quantizing the time interval within the range of around 0.003 second, for example. The frequency of the quantized time interval “elapsed” is stored in “iDistNoteOn[elapsed]”.

The strike and release of a note is considered as one set, and a performance action starts with the strike of a note. Therefore, the interval between performance actions (performance action interval) is obtained by calculating the time interval between reception times of note-on messages, which are received every time a note(s) is struck.

The CPU 11 determines whether “elapsed<30 milliseconds” holds (Step S67).

When determining that “elapsed<30 milliseconds” does not hold (i.e., “elapsed” is equal to or longer than 30 milliseconds) (Step S67: NO), the CPU 11 increments a variable “iRepeatNoteCnt” for counting note-on messages in which a chord (multiple note strikes at almost the same time) is considered as one performance action. The CPU 11 also adds the value of “elapsed” to a variable “iSumInterval” for storing the total of note-on time intervals (i.e., the total of performance action intervals) (Step S68). The CPU 11 then proceeds to Step S69.

As mentioned above, the strike and release of a note is considered as one set, and a performance action starts with the strike of a note. Therefore, the number of times of performance actions can be counted by counting note-on messages, which are received every time a note(s) is struck.

When determining that “elapsed<30 milliseconds” holds (i.e., “elapsed” is shorter than 30 milliseconds) (Step S67: YES), the CPU 11 proceeds to Step S69.

When a chord is played, note-on messages are received for the respective performance actions on notes constituting the chord (i.e., strikes of notes constituting the chord). The performance actions corresponding to a chord are considered as one performance action to calculate the total number of times of performance actions and the total of performance action intervals. Specifically, when “elapsed” is extremely short (shorter than 30 milliseconds, i.e., Step S67: YES), the CPU 11 does not increment “iRepeatNoteCnt” or add “elapsed” to “iSumInterval”. That is, the CPU 11 counts multiple performance actions done within a predetermined time (herein, 30 milliseconds) as one performance action to calculate the total number of times of performance actions and the total of performance action intervals. In Step S67, “elapsed” is compared with the threshold (predetermined time) of 30 milliseconds as an example. However, the threshold is not limited to 30 milliseconds.

In Step S69, the CPU 11 increments a variable “iNoteCnt” for counting note-on messages (Step S69).

The CPU 11 adds a velocity value “iVel”, which is included in the received note data, to a variable “iSumVelocity” that stores the total of velocity values (Step S70).

The note number of the received note data is represented by “pit”, and “iNoteOn[pit]” indicates whether the note with the note number (pit) is on or off (struck or released). In “iNoteOn[pit]” of the note number, the CPU 11 stores “1” indicating that the note is on. The CPU 11 also increments “iUserPlayPitch[pit]” for storing the number of times of performance actions made on the note of the note number (Step S71). The CPU 11 then returns to Step S3 in FIG. 2.

In Step S61, when determining that the received note data does not include a note-on message (i.e., the received note data includes a note-off message) (Step S61: NO), the CPU 11 stores, in “iNoteOn[pit]” corresponding to the note number of the received note data, 0 (zero) indicating that the note is off (Step S72). The CPU 11 then returns to Step S3 in FIG. 2.

The CPU 11 repeats Steps S3 through S5 and repeats the timer process initiated in Step S2 at predetermined time cycles until determining that the condition to end the performance evaluation process is met in Step S3 in FIG. 2.

### (Timer Process)

FIG. 4 is a flowchart of the timer process that is executed at predetermined time cycles during the performance evaluation process. The timer process is executed by the CPU 11 in cooperation with the program stored in the ROM 13.

In the timer process, the CPU 11 firstly increments a variable “iTimeUnitCnt” that stores the number of times of the timer process (Step S21).

The CPU 11 calculates “iPoly” that represents the number of sounds produced at one time (hereinafter, polyphony) (Step S22).

In Step S22, the CPU 11 calculates/obtains “iPoly” by calculating how many “iNoteOn[pit]” have the value of 1, namely how many notes are currently on.

The CPU 11 adds “iPoly” calculated in Step S22 to a variable “iSumPoly” that stores the total of “iPoly” (Step S23).

The CPU 11 determines whether “iPoly=0” holds (Step S24).

When determining that “iPoly=0” holds (Step S24: YES), the CPU 11 determines whether it is before the start of performance (Step S28).

For example, if the CPU 11 has received no note-on message for a predetermined period of time since the start of the performance evaluation process, the CPU 11 determines that it is before the start of performance.

When determining that it is before the start of performance (Step S28: YES), the CPU 11 instructs the outputter 17 to output a reaction sound, such as cheers or clapping that encourage the performance (Step S29) and ends the timer process.

When determining that it is not before the start of performance (Step S28: NO), the CPU 11 determines whether the performance has ended (Step S30).

For example, when the state of “iPoly=0” has continued for a predetermined period of time since the start of performance, the CPU 11 determines that the performance has ended.

When determining that the performance has not ended (Step S30: NO), the CPU 11 ends the timer process.

When determining that the performance has ended (Step S30: YES), the CPU 11 instructs the outputter 17 to output a reaction sound, such as cheers or clapping at the end of performance (Step S31), and ends the timer process.

In Step S24, when determining that “iPoly=0” does not hold (Step S24: NO), the CPU 11 determines whether “iNoteCnt>32” holds (Step S25).

In Step S25, “iNoteCnt” (a variable for counting note-on messages) is compared with the predetermined value of 32 that is the number of note-on messages required for evaluation in the rapid-playing evaluation process. The value of 32 is an example, and the threshold is not limited to 32.

In Step S25, when determining that “iNoteCnt>32” does not hold (Step S25: NO), the CPU 11 ends the timer process.

In Step S25, when determining that “iNoteCnt>32” holds (Step S25: YES), the CPU 11 executes the rapid-playing evaluation process (Step S26).

### (Rapid-Playing Evaluation Process)

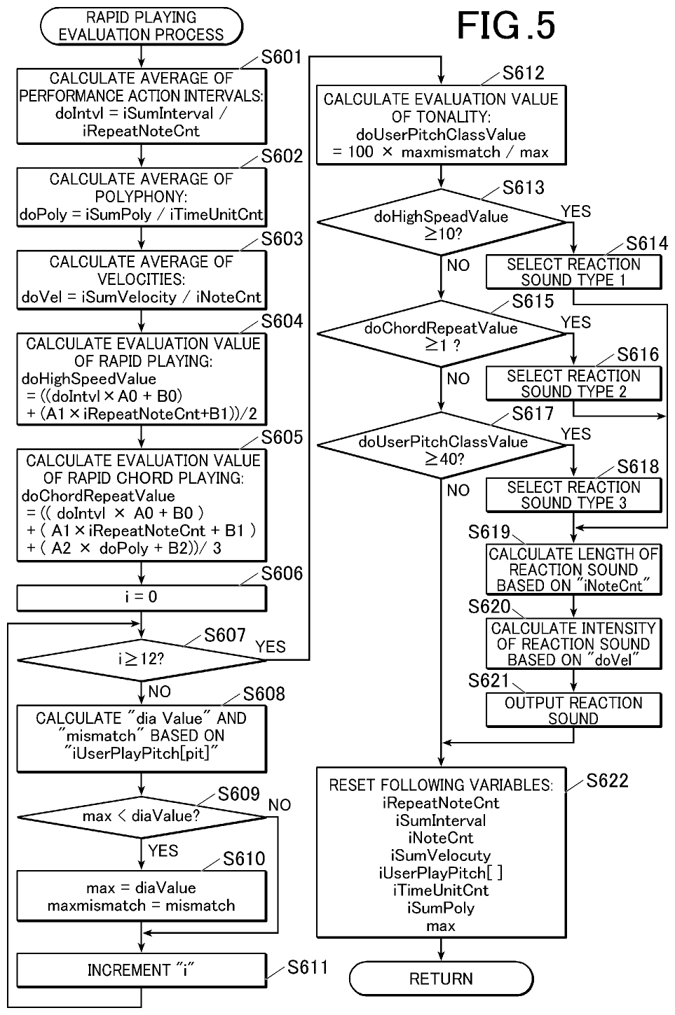

FIG. 5 is a flowchart of the rapid-playing evaluation process. The rapid-playing evaluation process is executed by the CPU 11 in cooperation with the program stored in the ROM 13.

In the rapid-playing evaluation process, the CPU 11 firstly calculates the average of performance action intervals: doIntvl=iSumInterval/iRepeatNoteCnt (Step S601). The calculation yields the average of note-on time intervals in which chords (strikes of notes at almost the same time) are taken into account.

The CPU 11 calculates the average of polyphony per timer process: doPoly=iSumPoly/iTimeUnitCnt (Step S602).

The CPU 11 calculates the average of velocity: doVel=iSumVelocity/iNoteCnt (Step S603).

The CPU 11 calculates the evaluation value of rapid playing “doHighSpeedValue” by using the following Expression 1 on the basis of “doIntvl” (the average of performance action intervals) and “iRepeatNoteCnt” (the number of times of performance actions) (Step S604).

doHighSpeedValue=((doIntvl×A0+B0)+(A1×iRepeatNoteCnt+B1))/2 Expression 1

When a performer (player) is doing a performance in front of the audience, the performer may receive applause or cheers by the audience. This is because the audience regard the performance as “great”, “cool”, or “superb”. Generally, playing sixteenth notes successively for one or more bars at around 160 bpm may often be regarded as “great”, “cool”, or “superb”. In other words, the speed of rapid playing and the number of rapidly played notes are important factors for the performance to be highly evaluated. The Expression 1 for calculating “doHighSpeedValue” is determined by focusing on these factors. “doHighSpeedValue” is calculated on the basis of the performance action intervals and the number of times of performance actions.

The coefficients A0, B0, A1, B1 in the Expression 1 for calculating “doHighSpeedValue” are experimentally obtained. For example, the coefficients A0, B0 are determined such that “doIntvl× A0+B0=100 (score)” is satisfied when “doIntvl” is 100 milliseconds; and such that “doIntvl×A0+B0=0 (score)” is satisfied when “doIntvl” is 180 milliseconds. In this case, the coefficients are: A0=100/(100−180), B0=−A0×180. Further, the coefficients A1, B1 are determined such that “A1×iRepeatNoteCnt+B1=100 (score)” is satisfied when “iRepeatNoteCnt” is 32; and such that “A1×iRepeatNoteCnt+B1=0” is satisfied when “iRepeatNoteCnt” is 8. In this case, the coefficients are: A1=100/(32−8), B1=−A1×8. The maximum value of “doHighSpeedValue” is 100 (score).

The CPU 11 calculates the evaluation value of rapid chord playing “doChordRepeatValue” by using the following Expression 2 on the basis of “doIntvl” (the average of performance action intervals), “iRepeatNoteCnt” (the number of times of performance actions), and “doPoly” (the average of polyphony) (Step S605).

doChordRepeatValue=((doIntvl×A0+B0)+(A1×iRepeatNoteCnt+B1)+(A2×doPoly+B2))/3 Expression 2

“doChordRepeatValue” reflects polyphony, which is the number of sounds produced at one time, as well as the performance action intervals and the number of times of performance actions used in evaluating rapid playing. Generally, the greater the polyphony is, the more likely the performance is considered “great”, “cool” and “superb”.

The coefficients A0, B0, A1, B1, A2, B2 in the Expression 2 for calculating “doChordRepeatValue” are experimentally obtained. For example, as described above, A0, B0, A1, B1 are determined as follows: A0=100/(100−180); B0=−A0×180; A1=100/(32−8); B1=−A1×8. Further, A2, B2 are determined such that “A2×doPoly+B2=100 (score)” is satisfied when “doPoly” is 4.0; and such that “A2×doPoly+B2=0 (score)” when “doPoly” is 1.5. In this case, the coefficients are: A2=100.0/(4.0−1.5); B2=−A2×1.5. The maximum value of “doChordRepeatValue” is 100 (score).

The CPU 11 executes Steps S606 to S612 to calculate the evaluation value of tonality: “doUserPitchClassValue”.

The CPU 11 firstly sets a variable “i” to zero (0) (Step S606).

The CPU 11 determines whether “i≥12” holds (Step S607).

Herein, “12” is the number of kinds of keys that consist of different groups of sounds (notes). In this embodiment, the keys are numbered from 0 to 11.

When determining that “i≥12” does not hold (Step S607: NO), the CPU 11 calculates the sounds constituting the key “i” on the basis of the data of sounds constituting C major stored in the ROM 13 and obtains the data of sounds constituting the key “i”. When the key “i” is C major, this calculation is not required. The CPU 11 then sums up values of “iUserPlayPitch[i]” corresponding to the sounds constituting the key “i” to obtain “diaValue” that represents the number of times the sounds constituting the key “i” are played. The CPU 11 also sums up the values of “iUserPlayPitch[pit]” corresponding to the sounds not constituting the key “i” (i.e., the sounds other than the sounds constituting the key “i”) to obtain “mismatch” that represents the number of times the sounds not constituting the key “i” are played (Step S608).

Alternatively, the ROM 13 may store data of sounds constituting the respective keys, and the CPU 11 may retrieve the data corresponding to the key “i” (target key for which the evaluation value is calculated) from the ROM 13 in Step S608.

The CPU 11 refers to a variable “max” and determines whether “max<diaValue” holds (Step S609).

When determining that “max<diaValue” holds (Step S609: YES), the CPU 11 stores “diaValue” in the variable “max” and stores “mismatch” in the variable “maxmismatch” (Step S610). The CPU 11 then proceeds to Step S611.

When determining that “max<diaValue” does not hold (Step S609: YES), the CPU 11 proceeds to Step S611.

In Step S611, the CPU 11 increments “i” (Step S611) and returns to Step S607. The CPU 11 repeats Steps S607 to S611 until “i” is equal to or greater than 12.

When determining that “i≥12” holds (Step S606: YES), the CPU 11 calculates the evaluation value of tonality “doUserPitchClassValue” by using the following Expression 3 (Step S612).

doUserPitchClassValue=100×maxmismatch/max Expression 3

Generally, a performance is evaluated as “great”, “cool”, or “superb” by the audience when the performance includes sounds constituting a key different from the key of the piece of music played.

For example, major C consists of only white notes: C, D, E, F, G, A, B. When the performer plays black notes while playing a tune of C major, the audience may evaluate the performance as “great”, “cool” or “superb”. In consideration of the above, in Steps S607 to S612, the CPU 11 obtains “diaValue” for the respective keys. “diaValue” represents the number of times the sounds constituting the key are played. The CPU 11 then determines the key having the greatest “diaValue” to be the key of the music being played. The CPU 11 then calculates the ratio of “maxmismatch” to “max”. “maxmismatch” represents the number of times the sounds not constituting the key of the music are played, whereas “max” represents the number of times the sounds constituting the key of the music are played. The calculated ratio “doUserPitchClassValue” is obtained as the evaluation value of tonality. The greater “doUserPitchClassValue” is, the higher the evaluation is.

The CPU 11 determines whether “doHighSpeedValue≥10” holds (Step S613). The threshold for “doHighSpeedValue” may be determined appropriately between 0 and 100.

When determining that “doHighSpeedValue≥10” holds (Step S613: YES), the CPU 11 selects the reaction sound type 1 (e.g., cheers) and retrieves sound data of the reaction sound type 1 from ROM 13 (step S614). The CPU 11 then proceeds to Step S619.

When determining that “doHighSpeedValue” is less than 10 (Step S613: NO), the CPU 11 determines whether “doChordRepeatValue≥1” holds (Step S615). When determining that “doChordRepeatValue≥1” holds (Step S615: YES), the CPU 11 selects the reaction sound type 2 (e.g., enthusiastic yells) and retrieves sound data of the reaction sound type 2 from the ROM 13 (Step S616). The CPU 11 then proceeds to Step S619.

When determining that “doChordRepeatValue” is less than 1 (Step S615: NO), the CPU 11 determines whether “doUserPitchClassValue≥40” holds (Step S617). When determining that “doUserPitchClassValue≥40” holds (Step S617: YES), the CPU 11 selects the reaction sound type 3 (e.g., finger-whistling) and retrieves sound data of the reaction sound type 3 from the ROM 13 (Step S618). The CPU 11 then proceeds to Step S619.

The predetermined thresholds used in Steps S613, S615, S617 are examples, and the thresholds are not limited to the above values. The reactivity (degree of how easily a reaction is output) can be controlled by adjusting the thresholds.

In Step S619, the CPU 11 calculates the length of the reaction sound on the basis of “iNoteCnt” (Step S619). In this embodiment, the greater the number of struck notes (note-on) is, the longer the reaction sound is. For example, the length of the reaction sound is calculated by using the following Expression 4.

Length of reaction sound=iNoteCnt×A+B(A and B are constants) Expression 4

The CPU 11 calculates the intensity of the reaction sound on the basis of “doVel” that represents the average of velocities (Step S620). In this embodiment, the greater the sounds produced by struck notes are, the greater the intensity of the reaction sound is. For example, the intensity of the reaction sound is calculated by using the following Expression 5.

Intensity of reaction sound=C×iSumVelocity/iNoteCnt(C is constant) Expression 5

The CPU 11 instructs the outputter 17 to output the selected reaction sound for the calculated length and at the calculated intensity on the basis of the retrieved sound data (Step S621). The CPU 11 then proceeds to Step S622.

In the above, the reaction sounds 1 to 3 are voices/sounds expressing joy (e.g., cheers, enthusiastic yells, finger-whistling) but are not limited thereto. The reaction sounds may be sound effects expressing joy (e.g., clapping).

When “doHighSpeedValue” is less than 10 (Step S613: NO); “doChordRepeatValue” is less than 1 (Step S615: NO); and “doUserPitchClassValue” is less than 40 (Step S617: NO), the CPU 11 proceeds to Step S622.

In Step S622, the CPU 11 resets the following variables (Step S622). The CPU 11 then ends the rapid-playing evaluation process and proceeds to Step S27 in FIG. 4.

In Step S622, following variables are reset: iRepeatNoteCnt, iSumInterval, iNoteCnt, iSumVelocity, iUserPlayPitch[ ], iTimeUnitCnt, iSumPoly, max.

As described above, in the rapid-playing evaluation process, the performance is evaluated without determining how much the multiple pieces of note data input in the performance match with correct pitch data. Thus, even when the performance is improvised, the performance can be appropriately evaluated.

The correct pitch data is stored beforehand in a memory before the performance starts. Generally, accuracy of the user's performance is evaluated by determining whether the pitch data input by the user's performance matches with the correct pitch data. This embodiment, however, does not involve such determination. This embodiment evaluates the user's performance no matter how the user plays the electronic musical instrument, namely no matter whether the user composes and plays a piece of music on the spot (i.e., the user improvises the performance).

### (Accuracy Evaluation Process)

In Step S27 of FIG. 4, the CPU 11 executes the accuracy evaluation process (Step S27).

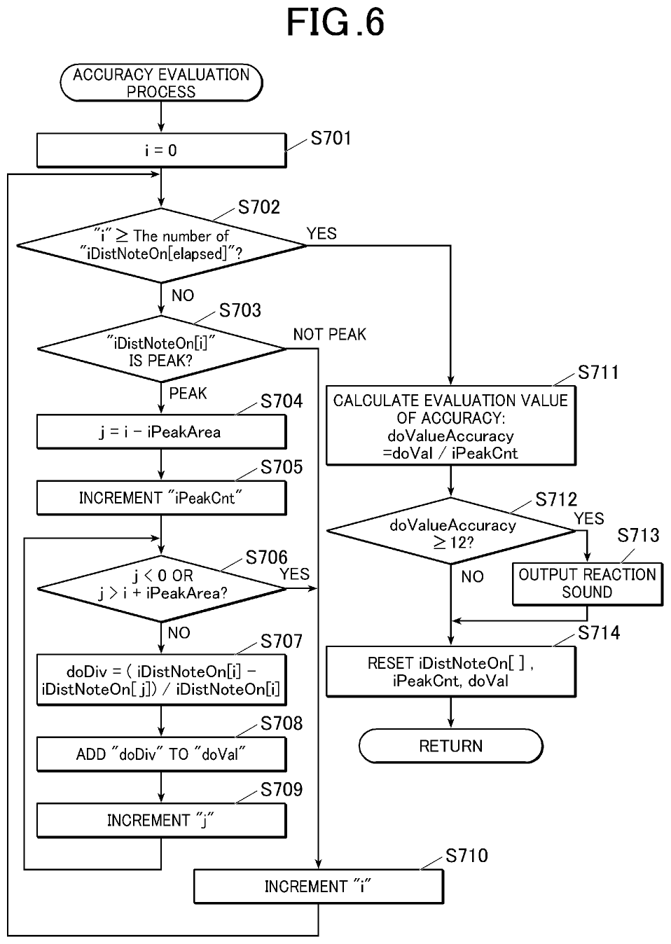

FIG. 6 is a flowchart of the accuracy evaluation process. The accuracy evaluation process is executed by the CPU 11 in cooperation with the program stored in the ROM 13.

In the accuracy evaluation process, accuracy of the performance is evaluated on the basis of the histogram (iDistNoteOn[elapsed]) of note-on time intervals (i.e., performance action intervals). For example, when only quarter notes (crotchets) are played at the constant tempo of 120 bpm, the histogram has only one peak at 0.5 second. When the tempo fluctuates in playing quarter notes, the histogram shows certain levels of frequencies around 0.5 second. In the accuracy evaluation process, the CPU 11 searches for a peak of the histogram and evaluates steepness of the peak as the accuracy of the performance.

In the accuracy evaluation process, the CPU 11 firstly sets a variable “i” to zero (0) (Step S701).

The CPU 11 determines whether “i≥the number of iDistNoteOn[elapsed]” holds (Step S702). The number of “iDistNoteOn[elapsed]” represents the number of bins in the histogram of “elapsed” (note-on time intervals, namely performance action intervals).

When determining that “i≥the number of iDistNoteOn[elapsed]” does not hold, namely determining that “i” is less than the number of bins in the histogram of “elapsed” (Step S702: NO), the CPU 11 determines whether “iDistNoteOn[i]” (frequency represented by the “i” bin in the histogram) is the peak (Step S703).

For example, when determining that the value of “iDistNoteOn[i]” is greater than the value of “iDistNoteOn[i−1]” and the value of “iDistNoteOn[i+1]”, the CPU 11 determines that “iDistNoteOn[i]” is a peak.

When determining that “iDistNoteOn[i]” is not the peak (Step S703: NOT PEAK), the CPU 11 increments the variable “i” (Step S710) and returns to Step S702.

When determining that “iDistNoteOn[i]” is the peak (Step S703: PEAK), the CPU 11 stores “i−iPeakArea” in a variable “j” (Step S704). The value of “iPeakArea” is determined beforehand for determining positions of bins at respective sides of the peak bin that are used for calculating the evaluation value of accuracy. For example, when five bins at respective sides of the peak bin are used for calculating the evaluation value of accuracy, the value of “iPeakArea” is 5. The range of bins at both sides of the peak bin is called a peak area.

The CPU 11 increments the variable “iPeakCnt” (Step S705).

The CPU 11 determines whether “j<0” or “j>i+IPeakArea” holds (Step S706).

When determining neither “j<0” or “j>i+IPeakArea” holds (Step S706: NO), the CPU 11 calculates “doDiv” by using the following Expression 6 (Step S707). “doDiv” represents the ratio of the frequency at the peak bin “i” to the frequency at the bin “j”.

doDiv=(iDistNoteOn[i]−iDistNoteOn[j])/iDistNoteOn[i] Expression 6

The CPU 11 adds “doDiv” to a variable “doVal” (Step S708) and increments the variable “j” (Step S709). The CPU 11 then returns to Step S706.

When determining that “j<0” or “j>i+iPeakArea” holds (Step S706: YES), the CPU 11 increments the variable “i” (Step S710) and returns to Step S702.

In Step S702, when determining that “i≥the number of iDistNoteOn[elapsed]” holds (Step S702: YES), the CPU 11 normalizes “doVal” on the basis of the number of peaks to calculate the evaluation value of accuracy “doValueAccuracy” by using the following Expression 7 (Step S711).

doValueAccuracy=doVal/iPeakCnt Expression 7

The CPU 11 determines whether “doValueAccuracy” is equal to or greater than a predetermined threshold (e.g., 12) (Step S712).

When determining that “doValueAccuracy” is equal to or greater than a predetermined threshold (e.g., 12) (Step S712: YES), the CPU 11 determines that the performance is highly accurate and instructs the outputter 17 to output a predetermined reaction sound (e.g., cheers, clapping) (Step S713). The CPU 11 then proceeds to Step S714.

When determining that “doValueAccuracy” is less than a predetermined threshold (e.g., 12) (Step S712: NO), the CPU 11 proceeds to Step S714.

In Step S714, the CPU 11 resets the variables “iDistNoteOn[ ]”, “iPeakCnt”, and “doVal” (Step S714) and ends the accuracy evaluation process.

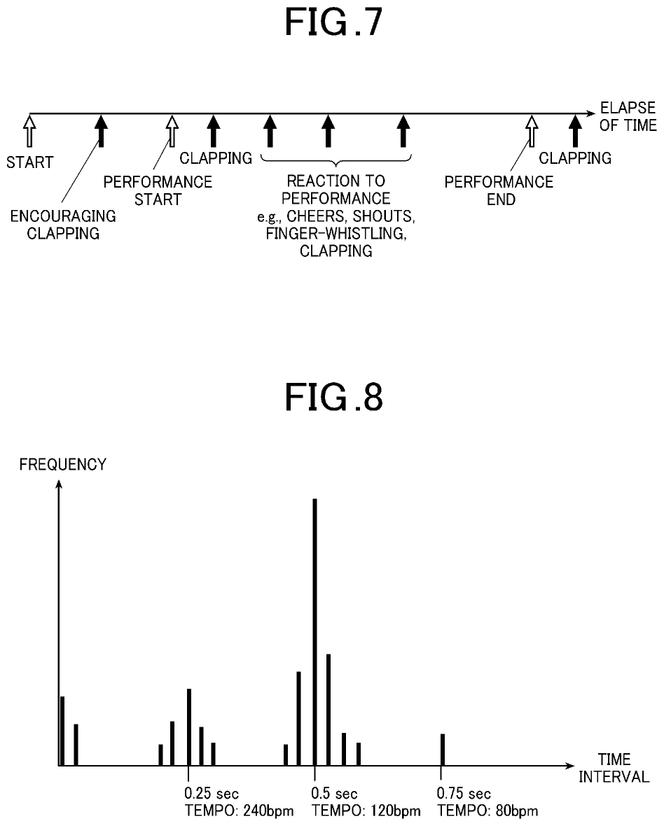

FIG. 7 shows timings of outputting reaction sounds from the start to the end of the performance evaluation process in a time series. The reaction sounds are output at the timings indicated by black arrows. As shown in FIG. 7, voices or sound effects expressing joy (e.g., cheers, enthusiastic yells, finger-whistling, clapping) are output during the performance when the performance is highly evaluated as well as at the start and the end of the performance. This brings satisfaction to the performer as if he/she is playing in front of the audience.

Preferably, “iDistNoteOn[elapsed]”, which represents the frequencies of respective note-on time intervals (performance action intervals) obtained in the performance evaluation process, may be visualized as a histogram and displayed on the display 15, for example.

FIG. 8 shows an example of histograms showing “iDistNoteOn[elapsed]”, which represents frequencies of respective note-on time intervals (performance action intervals).

For example, when only quarter notes (crotchets) are played at a constant tempo of 120 bpm, the histogram has only one peak at 0.5 second, as described above. When the tempo fluctuates in playing quarter notes, the histogram shows certain levels of frequencies around 0.5 second. By viewing the histogram of note-on time intervals (performance action intervals), the user can visually check the tempo of his/her performance and how much the tempo fluctuates. For example, when the user practices the instrument at the tempo of 120, the user can view the histogram to check whether he/she was able to play at the tempo.

As shown in FIG. 8, the histogram may be displayed such that the user can instantly recognize the tempo corresponding to the peak position. This allows the user to check the tempo of his/her performance. Further, a unit for resetting the histogram may be added. Further, the histogram may also be generated and visualized on the basis of performances done during a certain period of time in the past. Still further, the histogram of the number of notes in the previous performance may be generated and visualized.

As described above, The CPU 11 of the information processing apparatus 1 evaluates at least either the speed or tonality of the performance actions of a performance based on performance actions, wherein performance actions within a predetermined period of time are counted as one operation action. The CPU 11 then instructs the outputter 17 to output a reaction sound corresponding to the evaluation according to a timing of the evaluation during the performance.

The performance is thus evaluated without determining how much the multiple pieces of note data input by the user's performance match with correct pitch data. The performance can therefore be appropriately evaluated even if it is improvised. Further, reaction sounds corresponding to the evaluation (e.g., sounds and sound effects expressing joy) are output. This brings satisfaction to the user as if he/she is playing in front of the audience.

For example, the CPU 11 determines a key of music based on the pieces of note data corresponding to the performance actions and data of sounds constituting one key of music; determines an evaluation value of tonality based on data of sounds constituting the determined key of music and the pieces of note data; and instructs the outputter 17 to output the reaction sound corresponding to the evaluation of tonality in response to the evaluation value of tonality reaching a threshold. For example, the CPU 11 calculates a ratio of the number of times operation action receivers corresponding to sounds not constituting the determined key of music are played to the number of times operation action receivers corresponding to sounds constituting the determined key of music are played, based on the data of sounds constituting the determined key of music and the pieces of note data. The CPU 11 then determines the evaluation value of tonality based on the calculated ratio.

The performance can therefore be appropriately evaluated on the basis of tonality even when the user improvises the performance. Further, reaction sounds corresponding to the evaluation are output. This brings satisfaction to the user as if he/she is playing in front of the audience.

Further, the CPU 11 may obtain performance action intervals and/or the number of times of performance actions, based on the pieces of note data corresponding to the performance actions, wherein multiple performance actions within a predetermined period of time are counted as one operation action. The CPU 11 may then determine an evaluation value of rapid playing based on the obtained performance action intervals and/or the number of times of performance actions. The CPU 11 may then instruct the outputter 17 to output the reaction sound corresponding to the evaluation of rapid playing in response to the evaluation value of rapid playing reaching a threshold.

The rapid playing in the performance can therefore be appropriately evaluated even when the user improvises the performance. Further, reaction sounds corresponding to the evaluation are output. This brings satisfaction to the user as if he/she is playing in front of the audience.

Further, the CPU 11 may obtain the number of simultaneously produced sounds based on the pieces of note data. The CPU 11 may determine the evaluation value of rapid chord playing based on the obtained number of simultaneously produced sounds and based on the performance action intervals and/or the number of times of performance actions. The CPU 11 may then instruct the outputter 17 to output the reaction sound corresponding to the evaluation value of rapid chord playing in response to the evaluation value of rapid chord playing reaching a threshold.

The rapid chord playing in the performance can therefore be appropriately evaluated even when the user improvises the performance. Further, reaction sounds corresponding to the evaluation are output. This brings satisfaction to the user as if he/she is playing in front of the audience.

Further, the CPU 11 may perform the evaluation at every predetermined timing. According to such a configuration, the CPU 11 evaluates the performance every predetermined timing during the performance, and the CPU 11 instructs the outputter 17 to output the reaction sound corresponding to the evaluation when the evaluation meets a criterion (criteria). This brings satisfaction to the performer as if he/she is playing in front of the audience.

The embodiment and modifications described above are preferable examples of the program, the information processing apparatus, the performance evaluation system, and the performance evaluation method. The present invention is not limited to these embodiment/modifications.

For example, in the above embodiment, the reaction sounds (e.g., voices/sound effects expressing joy) are output when any of the evaluation value of rapid playing, the evaluation value of rapid chord playing, and the evaluation value of tonality is equal to or greater than a predetermined threshold. However, each of the evaluation values may have multiple thresholds so that the reaction sounds differ depending on the thresholds reached or exceeded. For example, assume that first and second thresholds are set (first threshold<second threshold). In the case, the reaction sound may be more intense when “evaluation value≥second threshold” holds than when “second threshold>evaluation value≥first threshold” holds.

In the above embodiment, the CPU 11 outputs any one of reaction sound types 1, 2, 3 from the outputter 17 even when multiple evaluation values (evaluation values of rapid playing, rapid chord playing, and tonality) are equal to or greater than their respective thresholds. However, in such a case, the CPU 11 may instruct the outputter 17 to output multiple reaction sound types 1-3 overlapped to each other according to the types of evaluation values that have reached/exceeded the thresholds.

In the above embodiment, the evaluation value of rapid playing, which represents evaluation of the speed of performance actions, is calculated on the basis of both the performance action intervals and the number of times of performance actions. However, the evaluation value of rapid playing may be calculated on the basis of either the performance action intervals or the number of times of performance actions. Similarly, although the evaluation value of rapid chord playing is calculated on the basis of three parameters: the performance action intervals, the number of times of performance actions, and the polyphony (the number of sounds produced at one time), the evaluation value of rapid chord playing may be calculated on the basis of (i) either the performance action intervals or the number of times of performance actions and (ii) the polyphony.

Although the electronic musical instrument 2 is a keyboard as an example in the above embodiment, the electronic musical instrument 2 may be any other electronic musical instrument, such as an electric guitar or a MIDI violin.

In the above embodiment, the ROM is used as an example of computer-readable medium that stores the programs of the present invention. However, the computer-readable medium is not limited to the ROM. As other computer readable media, a portable storage medium (e.g., hard disc, solid state drive (SSD), CD-ROM) can be used. A carrier wave is also applicable as a medium for providing the program data of the present invention via a communication line.

Other detailed configurations and operations of apparatuses constituting the performance evaluation system can also be appropriately modified without departing from the scope of the present invention.

Although the embodiments of the present invention have been described, the scope of the present invention is not limited to the above embodiment. The scope of the present invention includes the scope of the present invention described in the scope of claims and the scope of their equivalents that include modifications irrelevant to the nature of the present invention.

What is claimed is:

1. A method for a computer to perform:
evaluating rapid chord playing and/or tonality based on performance actions of a performance; and
instructing, during the performance, an outputter to output a reaction sound corresponding to the evaluation.

2. The method according to claim 1, further comprising determining a key of music based on pieces of note data corresponding to the performance actions and based on data of sounds constituting one key of music,
wherein the evaluating includes determining an evaluation value of tonality based on data of sounds constituting the determined key of music and the pieces of note data,
wherein the instructing instructs the outputter to output the reaction sound corresponding to the evaluation of tonality in response to the evaluation value of tonality reaching a threshold.

3. The method according to claim 2, further comprising:
calculating a ratio of the number of times operation action receivers corresponding to sounds not constituting the determined key of music are played to the number of times operation action receivers corresponding to sounds constituting the determined key of music are played, based on the data of sounds constituting the determined key of music and the pieces of note data,
wherein the evaluating determines the evaluation value of tonality based on the calculated ratio.

4. The method according to claim 1, further comprising:
obtaining performance action intervals and/or the number of times of operation actions based on the pieces of note data corresponding to the performance actions, wherein in the obtaining, multiple performance actions within a predetermined period of time are counted as one operation action,
wherein the evaluating includes determining an evaluation value of rapid playing based on the performance action intervals and/or the number of times of performance actions obtained,
wherein the instructing instructs the outputter to output the reaction sound corresponding to the evaluation of rapid playing in response to the evaluation value of rapid playing reaching a threshold.

5. The method according to claim 4, further comprising:
obtaining the number of simultaneously produced sounds based on the pieces of note data corresponding to the performance actions,
wherein the evaluating includes determining an evaluation value of rapid chord playing based on the number of simultaneously produced sounds and based on the performance action intervals and/or the number of times of performance actions,
wherein the instructing instructs the outputter to output the reaction sound corresponding to the evaluation of rapid chord playing in response to the evaluation value of rapid chord playing reaching a threshold.

6. The method according to claim 1, wherein the evaluating is performed at every predetermined timing.

7. An information processing apparatus comprising:
an obtainer that obtains pieces of note data output from an electronic musical instrument, the pieces of note data corresponding to performance actions; and
a processor that
evaluates a speed and/or tonality of the performance actions of a performance based on the pieces of note data corresponding to the performance actions, wherein multiple performance actions within a predetermined period of time are counted as one operation action; and
instructs an outputter to output a reaction sound corresponding to the evaluation according to a timing of the evaluation during the performance.

8. The information processing apparatus according to claim 7, wherein
the processor determines a key of music based on the pieces of note data corresponding to the performance actions and based on data of sounds constituting one key of music,
in the evaluating, the processor determines an evaluation value of tonality based on data of sounds constituting the determined key of music and the pieces of note data,
in the instructing, the processor instructs the outputter to output the reaction sound corresponding to the evaluation of tonality in response to the evaluation value of tonality reaching a threshold.

9. The information processing apparatus according to claim 8, wherein
the processor calculates a ratio of the number of times operation action receivers corresponding to sounds not constituting the determined key of music are played to the number of times operation action receivers corresponding to sounds constituting the determined key of music are played, based on the data of sounds constituting the determined key of music and the pieces of note data, and
the processor determines the evaluation value of tonality based on the calculated ratio.

10. The information processing apparatus according to claim 7, wherein
the processor obtains performance action intervals and/or the number of times of performance actions based on the pieces of note data corresponding to the performance actions, wherein multiple performance actions within a predetermined period of time are counted as one operation action,
in the evaluating, the processor evaluates the speed by determining an evaluation value of rapid playing based on the performance action intervals and/or the number of times of performance actions obtained, and
in the instructing, the processor instructs the outputter to output the reaction sound corresponding to the evaluation of rapid playing in response to the evaluation value of rapid playing reaching a threshold.

11. The information processing apparatus according to claim 10, wherein
the processor obtains the number of simultaneously produced sounds based on the pieces of note data corresponding to the performance actions,
in the evaluating, the processor determines the evaluation value of rapid chord playing based on the number of simultaneously produced sounds and based on the performance action intervals and/or the number of times of performance actions, and
in the instructing, the processor instructs the outputter to output the reaction sound corresponding to the evaluation of rapid chord playing in response to the evaluation value of rapid chord playing reaching a threshold.

12. The information processing apparatus according to claim 7, wherein the processor performs the evaluation at every predetermined timing.

13. A performance evaluation system comprising an electronic musical instrument and an information processing apparatus, wherein
the electronic musical instrument outputs data corresponding to performance actions of a performance to the information processing apparatus, and
the information processing apparatus obtains the data, evaluates the performance based on the obtained data, and instructs an outputter to output a reaction sound corresponding to the evaluation of the performance.
